(19) United States
(12) Patent Application Publication
(10) Pub. No.: US 2026/0156284 A1
(43) Pub. Date: Jun. 4, 2026

(54) MESH DECODING DEVICE, MESH DECODING METHOD, AND PROGRAM

(71) Applicant: KDDI CORPORATION, Tokyo (JP)

(72) Inventors: Koki KISHIMOTO, Fujimino-shi (JP); Kei KAWAMURA, Fujimino-shi (JP)

(73) Assignee: KDDI CORPORATION, Tokyo (JP)

(21) Appl. No.: 19/421,265

(22) Filed: Dec. 16, 2025

Related U.S. Application Data
(63) Continuation of application No. PCT/JP2024/007923, filed on Mar. 3, 2024.

(30) Foreign Application Priority Data
Jul. 4, 2023 (JP) 2023-109928

(51) Int. Cl. H04N 19/44; G06T 9/00; H04N 19/70

(52) U.S. Cl. CPC H04N 19/44; G06T 9/001; H04N 19/70

(57) ABSTRACT

A mesh decoding device (200) according to the present invention includes: an atlas data decoding unit (207) configured to decode an atlas bit stream to generate and output control information. According to the present invention, it is possible to efficiently compress a displacement amount.

### CROSS-REFERENCE TO RELATED APPLICATIONS

The present application is a continuation of PCT Application No. PCT/JP 2024/007923, filed on Mar. 3, 2024, which claims the benefit of Japanese patent application No. 2023-109928 filed on Jul. 4, 2023, the entire contents of each application being incorporated herein by reference in its entirety.

### TECHNICAL FIELD

The present invention relates to a mesh decoding device, a mesh decoding method, and a program.

### BACKGROUND ART

In Non Patent Literature 1 (Khaled Mammou, Jungsun Kim, Alexis Tourapis, Dimitri Podborski, Krasimir Kolarov, “[V-CG] Apple's Dynamic Mesh Coding CfP Response,” ISO/IEC JTC 1/SC 29/WG 7 m5928 , April 2022), a mesh is decoded by being divided into a base mesh representing rough information and a displacement representing detailed information, and such a displacement is decoded by a video codec.

### SUMMARY OF THE INVENTION

However, in Non patent Literature 1, a function for separately decoding a part of a mesh and a method for controlling quality for each subdivision level (LoD) are not implemented, and the same processing is performed on the entire mesh, so that there is a problem that encoding according to local characteristics of mesh data cannot be performed.

Therefore, the present invention has been made in view of the above-described problems, and an object thereof is to provide a mesh decoding device, a mesh decoding method, and a program each capable of efficiently compressing a displacement amount.

A first feature of the present invention is summarized as a mesh decoding device including: an atlas data decoding unit configured to decode an atlas bit stream to generate and output control information.

A second feature of the present invention is summarized as a mesh decoding method, including: decoding an atlas bit stream to generate and output first control information.

A third feature of the present invention is summarized as a non-transitory computer-readable medium having stored thereon a program that is executable by a computer to cause the computer to function as a mesh decoding device, wherein the mesh decoding device includes an atlas data decoding unit configured to decode an atlas bit stream to generate and output first control information.

According to the present invention, it is possible to provide a mesh decoding device, a mesh decoding method, and a program each capable of efficiently compressing a displacement amount.

### BRIEF DESCRIPTION OF THE DRAWINGS

FIG. 1 is a diagram illustrating an example of a configuration of a mesh processing system 1 according to an embodiment.

FIG. 2 is a diagram illustrating an example of functional blocks of a mesh decoding device 200 according to an embodiment.

FIG. 3 is a diagram illustrating an example of a syntax configuration of an atlas bit stream.

FIG. 4A is a diagram illustrating an example of a syntax configuration of a PDU.

FIG. 4B is a diagram illustrating an example of a syntax configuration of an SDU.

FIG. 4C is a diagram illustrating an example of a syntax configuration of vdmc_lifting_transform_parameters.

FIG. 5A is a diagram illustrating an example of a base mesh.

FIG. 5B is a diagram illustrating an example of a subdivision mesh.

FIG. 6 is a diagram illustrating an example of functional blocks of a subdivision unit 203 of the mesh decoding device 200 according to an embodiment.

FIG. 7 is a flowchart illustrating an example of processing of the base mesh subdivision unit 203A of the subdivision unit 203 of the mesh decoding device 200 according to an embodiment.

FIG. 8 is a diagram illustrating an example of functional blocks of a displacement amount decoding unit 205 of the mesh decoding device 200 according to an embodiment.

### DESCRIPTION OF EMBODIMENTS

Hereinafter, embodiments of the present invention will be described with reference to the drawings. Note that components in the following embodiments can be replaced with existing components or the like as appropriate, and various variations including combinations with other existing components are possible. Therefore, the following description of the embodiments does not limit the contents of the invention described in the claims.

### First Embodiment

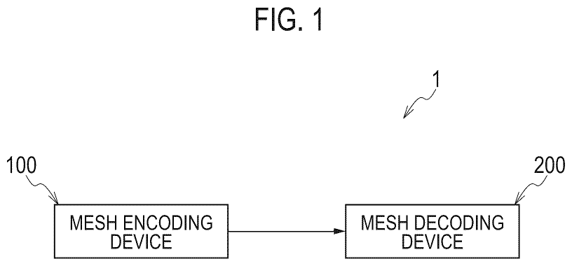

Hereinafter, a mesh processing system 1 according to the present embodiment will be described with reference to FIGS. 1 to 12.

FIG. 1 is a diagram illustrating an example of a configuration of the mesh processing system 1 according to the present embodiment. As illustrated in FIG. 1, the mesh processing system 1 includes a mesh encoding device 100 and a mesh decoding device 200.

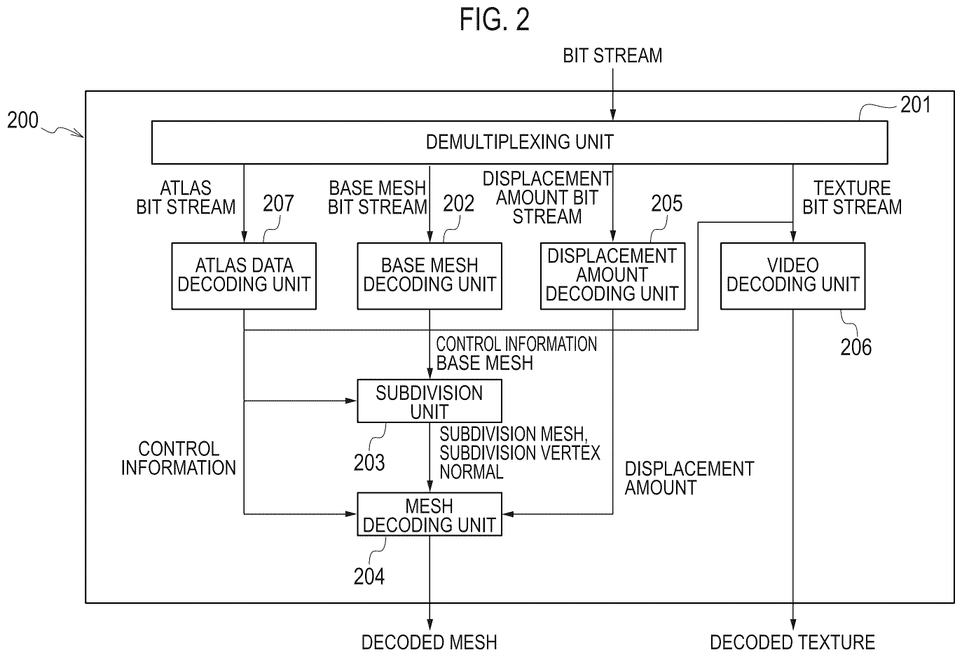

FIG. 2 is a diagram illustrating an example of functional blocks of the mesh decoding device 200 according to the present embodiment.

As illustrated in FIG. 2, the mesh decoding device 200 includes a demultiplexing unit 201, a base mesh decoding unit 202, a subdivision unit 203, a mesh decoding unit 204, a displacement amount decoding unit 205, a video decoding unit 206, and an atlas data decoding unit 207.

The demultiplexing unit 201 is configured to separate a multiplexed bit stream into an atlas bit stream, a sub-mesh bit stream, a displacement bit stream, a texture bit stream, and an atlas bit stream.

The atlas data decoding unit 207 is configured to decode the atlas bit stream to output control information (first control information).

The base mesh decoding unit 202 is configured to decode the base mesh bit stream to generate and output control information (second control information) and a base mesh.

The subdivision unit 203 is configured to decode the control information output from the atlas data decoding unit 207, the control information output from the base mesh decoding unit 202, and the base mesh to output the subdivision mesh and the subdivision vertex normal.

Specifically, the subdivision unit 203 is configured to generate and output the added subdivision vertices and the connection information thereof from the base mesh decoded by the base mesh decoding unit 202 by the subdivision method indicated by the above-described control information.

The mesh decoding unit 204 is configured to generate and output a decoded mesh by using the subdivision mesh generated by the subdivision unit 203 and the displacement decoded by the displacement decoding unit 205.

The mesh decoding unit 204 is configured to generate a decoded mesh using the control information output from the atlas data decoding unit 207, the displacement amount, the subdivision mesh, and the subdivision vertex normal as inputs.

Specifically, the mesh decoding unit 204 is configured to generate and output a decoded mesh using the subdivision mesh generated by the subdivision unit 203, the subdivision vertex normal, and the displacement amount decoded by the displacement amount decoding unit 205.

The displacement decoding unit 205 is configured to decode a displacement bit stream to generate and output a displacement.

The video decoding unit 206 is configured to decode and output texture by video codec.

### Atlas Data Decoding Unit 207

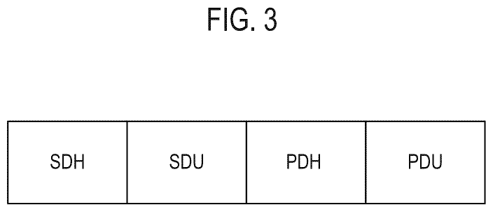

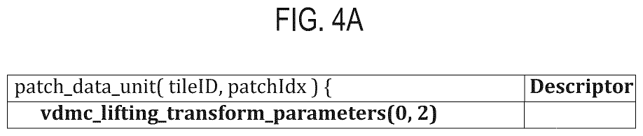

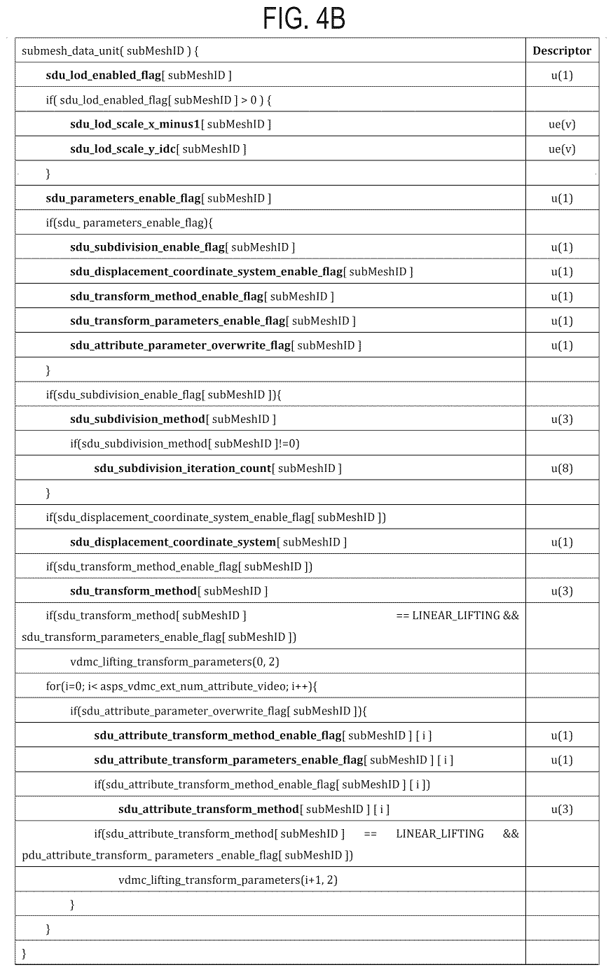

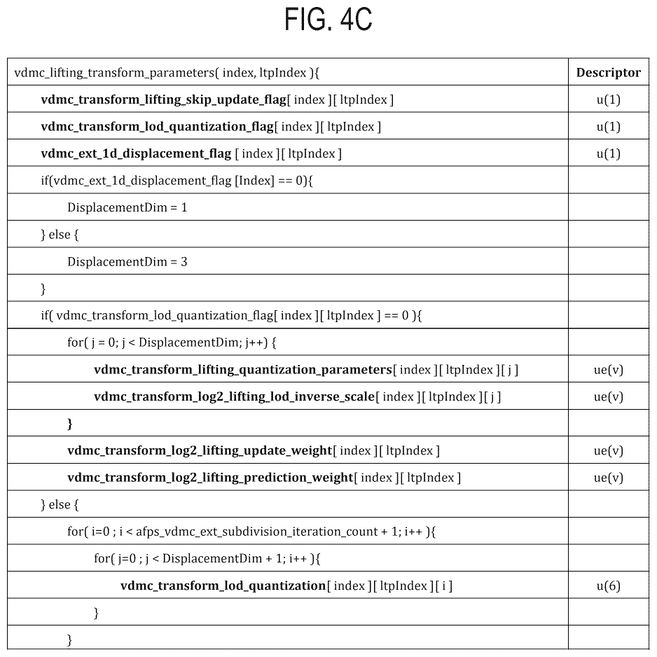

Hereinafter, the control information decoded by the atlas data decoding unit 207 will be described with reference to FIGS. 3 and 4.

FIG. 3 is a diagram illustrating an example of a syntax configuration of the atlas bit stream.

As illustrated in FIG. 3, firstly, the atlas bit stream may include a submesh data header (SDH), which is a set of header information of submeshes.

Second, the atlas bit stream may include a submesh data unit (SDU) representing data of control information related to the submesh.

Third, the atlas bit stream may include a patch data header (PDH) that is a set of patch header information.

Fourth, the atlas bit stream may include a patch data unit (PDU) representing data of control information related to the patch.

Here, the submesh is a unit of mesh that can be encoded/decoded singly. The base mesh and the displacement amount are independently defined for each submesh. In addition, the patch is defined as one region included in the submesh.

Hereinafter, an example of a syntax configuration of the SDU will be described with reference to FIG. 4B. FIG. 4B is a diagram illustrating an example of a syntax configuration of the SDU. Here, if syntax functions are similar, a syntax name different from the syntax name illustrated in FIG. 4B may be used.

In the syntax configuration of the SDU illustrated in FIG. 4B, a Description column indicates how each syntax is encoded. Further, ue(v) means an unsigned 0-order exponential-Golomb code, and u(n) means an n-bit flag.

The SDU includes control signal sdu_parameters_enable_flag indicating whether to define sdu_subdivision_enable_flag, sdu_displacement_coordinate_system_enable_flag, sdu_transform_method_enable_flag, sdu_transform_parameters_enable_flag, and sdu_attribute_parameter_overwrite_flag for each submesh.

sdu_subdivision_enable_flag is a control signal indicating whether subdivision is performed for each submesh.

sdu_displacement_coordinate_system_enable_flag is a control signal indicating whether to set a coordinate system that defines a displacement amount for each submesh. For example, when a value of sdu_displacement_coordinate_system_enable_flag is “1”, the coordinate system of the displacement amount may be defined for each submesh, or when a value of sdu_displacement_coordinate_system_enable_flag is “0”, the displacement amount may be defined in a default coordinate system. The default coordinate system may use a known coordinate system, such as a Cartesian coordinate system.

sdu_transform_method_enable_flag is a control signal indicating whether to set a displacement amount encoding method for each submesh. For example, when a value of sdu_transform_method_enable_flag is “1”, a displacement amount encoding method may be defined for each submesh, or when a value of sdu_transform_method_enable_flag is “0”, a default displacement amount encoding method may be used. The default displacement amount encoding method may use a known displacement amount encoding method such as a linear wavelet transform.

sdu_transform_parameters__enable_flag is a control signal indicating whether to define the encoding parameter of the displacement amount for each submesh. For example, when the value of sdu_transform_parameters__enable_flag is “1”, a control signal related to the encoding parameter of the displacement amount may be defined for each submesh, or when the value of sdu_transform_parameters__enable_flag is “0”, a default encoding parameter of the displacement amount may be used.

The SDU includes control signal sdu_attribute_parameter_overwrite_flag indicating whether to define sdu_attribute_transform_method_enable_flag, sdu_attribute_transform_parameters_enable_flag, and sdu_attribute_transform_method for each submesh.

The SDU includes sdu_subdivision_method which is a control signal representing a subdivision method for each submesh. For example, when the value of sdu_subdivision_method is “1”, it may be defined to divide each submesh by the Mid-edge division method, or when the value of sdu_subdivision_method is “0”, another known subdivision method may be defined.

The SDU includes sdu_subdivision_iteration_count which is a control signal representing the number of times of subdivision for each submesh.

The SDU includes sdu_transform_method which is a control signal representing a displacement amount encoding method for each submesh. For example, when the value of sdu_transform_method is “1”, the displacement amount may be encoded using the linear wavelet transform for each submesh, or when the value of sdu_transform_method is “0”, another known displacement amount encoding method may be defined.

The SDU includes sdu_attribute_transform_method_enable_flag which is a control signal indicating whether the encoding method in the attribute information is set for each submesh. For example, when the value of sdu_attribute_transform_method_enable_flag is “1”, the displacement amount of the attribute information may be defined by the linear wavelet transform for each submesh, or when the value of sdu_attribute_transform_method_enable_flag is “0”, the default encoding method may be used.

The SDU includes sdu_attribute_transform_parameters_enable_flag which is a control signal indicating whether to set a control signal related to a displacement amount encoding method in attribute information for each submesh. For example, when a value of sdu_attribute_transform_parameters_enable_flag is “1”, a control signal related to the encoding of the displacement amount in the attribute information may be defined for each submesh, or when a value of sdu_attribute_transform_parameters_enable_flag is “0”, a control signal related to the encoding of the default displacement amount may be defined.

The SDU includes sdu_attribute_transform_method which is a control signal representing a displacement amount encoding method in the attribute information for each submesh. For example, when a value of sdu_attribute_transform_method is “1”, it may be configured to encode the displacement amount using the linear wavelet transform for each submesh, or when a value of sdu_attribute_transform_method is “0”, it may be configured to define other known encoding methods.

The SDU includes vdmc_ext_ld_displacement_flag which is a control signal indicating whether one-dimensional displacement encoding is performed for each submesh. For example, the one-dimensional displacement encoding may be performed when a value of vdmc_ext_ld_displacement_flag is “1”.

The SDU includes vdmc_transform_lifting_quantization_parameters, which are control signals representing quantized values of a displacement amount at a vertex of a subdivision level 0 for each submesh.

The SDU includes vdmc_transform_log2_lifting_lod_inverse_scale which is a control signal representing a quantization scale value of a displacement amount between subdivision levels for each submesh.

At this point, vdmc_transform_lifting_quantization_parameters and vdmc_transform_log2_lifting_lod_inverse_scale may change the number of dimensions of the parameter based on the control signal indicating whether the one-dimensional displacement encoding is performed. For example, when the displacement amount is encoded by one-dimensional displacement encoding, the number of dimensions of the above-described parameter may be set to 1, and otherwise, the number of dimensions of the above-described parameter may be set to 3.

The SDU includes vdmc_transform_lod_quantization which is a control signal representing a quantization value for each subdivision level for each submesh.

At this point, vdmc_transform_lod_quantization may change the number of dimensions of the parameter based on the control signal indicating whether the one-dimensional displacement encoding is performed. For example, when the displacement amount is encoded by one-dimensional displacement encoding, the number of dimensions of the parameter of vdmc_transform_lod_quantization may be set to 1, and otherwise, the number of dimensions of vdmc_transform_lod_quantization may be set to 3.

With reference to FIG. 4A, control information related to the patch decoded by the atlas data decoding unit 207 will be described. FIG. 4A is a diagram illustrating an example of a configuration of a PDU that is patch-related syntax of an atlas bit stream.

The PDU includes vdmc_transform_lifting_quantization_parameters, which are control signals representing quantized values of a displacement amount at a vertex of a subdivision level 0 for each patch.

The PDU includes vdmc_transform_log2_lifting_lod_inverse_scale which is a control signal representing a quantization scale value of a displacement amount between subdivision levels for each patch.

At this point, vdmc_transform_lifting_quantization_parameters and vdmc_transform_log2_lifting_lod_inverse_scale may change the number of dimensions of the parameter based on the control signal indicating whether the one-dimensional displacement encoding is performed. For example, when the displacement amount is encoded by one-dimensional displacement encoding, the number of dimensions of the above-described parameter may be set to 1, and otherwise, the number of dimensions of the above-described parameter may be set to 3.

The PDU includes vdmc_transform_lod_quantization which is a control signal representing a quantization value for each subdivision level for each submesh.

vdmc_transform_lod_quantization may change the number of dimensions of the parameter based on the control signal indicating whether the one-dimensional displacement encoding is performed. For example, when the displacement amount is encoded by one-dimensional displacement encoding, the number of dimensions of the parameter of vdmc_transform_lod_quantization may be set to 1, and otherwise, the number of dimensions of vdmc_transform_lod_quantization may be set to 3.

vdmc_transform_lod_quantization may be configured to be calculated by a difference or multiplication on the basis of a subdivision level smaller than the current level.

### Base Mesh Decoding Unit 202

As described above, the base mesh decoding unit 202 is configured to decode the base mesh bit stream to generate and output the base mesh.

Here, the base mesh includes a plurality of vertices in a three-dimensional space and sides connecting the plurality of vertices. At this time, one or a plurality of base meshes may be used.

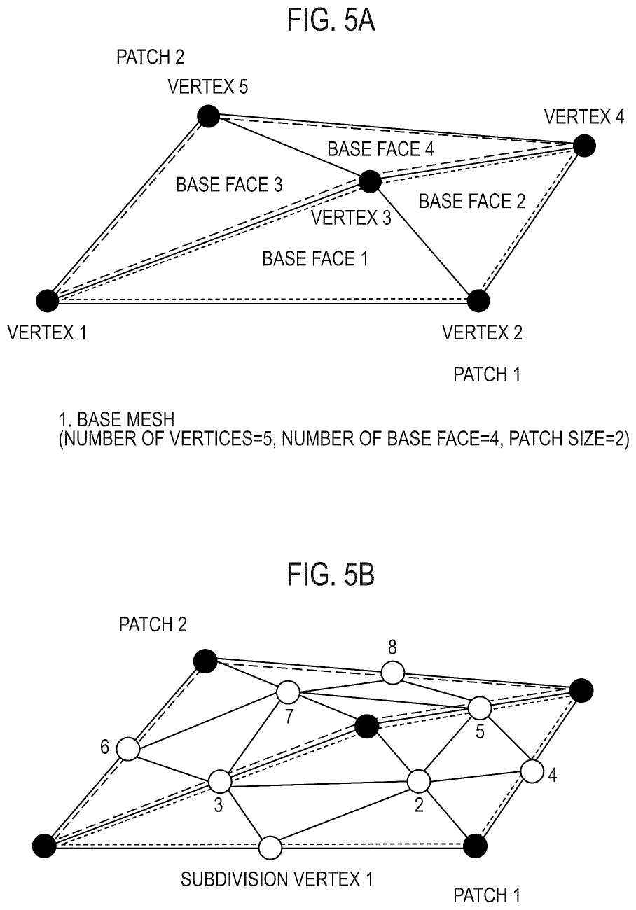

As illustrated in FIG. 5A, the base mesh is configured by combining basic faces represented by three vertices.

The base mesh decoding unit 202 may be configured to decode the base mesh bit stream using, for example, Draco described in Non patent Literature 2 (Google Draco, accessed on May 26, 2022 [Online], https://google.github.io/draco).

When there are a plurality of base meshes, the base mesh decoding unit 202 may be configured to independently decode the plurality of base meshes using Draco.

### Subdivision Unit 203

A method of decoding a subdivision mesh in the subdivision unit 203 will be described with reference to FIGS. 5 to 7.

The subdivision unit 203 is configured to calculate and output a subdivision mesh and a subdivision vertex normal on the basis of the base mesh.

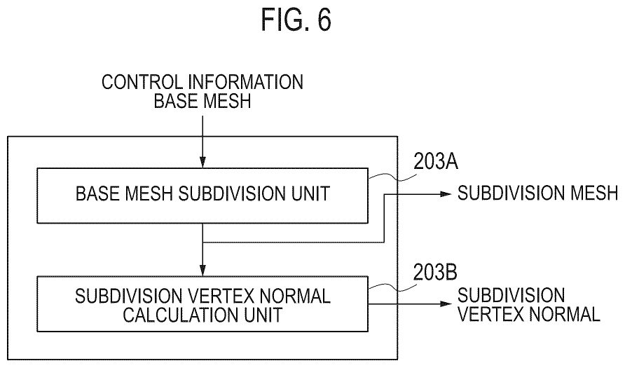

FIG. 6 is a diagram illustrating an example of functional blocks of the subdivision unit 203.

As illustrated in FIG. 6, the subdivision unit 203 includes a base mesh subdivision unit 203A and a subdivision vertex normal calculation unit 203B.

### Base Mesh Subdivision Unit 203A

The base mesh subdivision unit 203A is configured to subdivide the base mesh based on the control information input from the base mesh decoding unit 202 and the base mesh, and output the subdivision mesh.

In a case where there are a plurality of base meshes, the base mesh subdivision unit 203A may be configured to subdivide each base mesh independently.

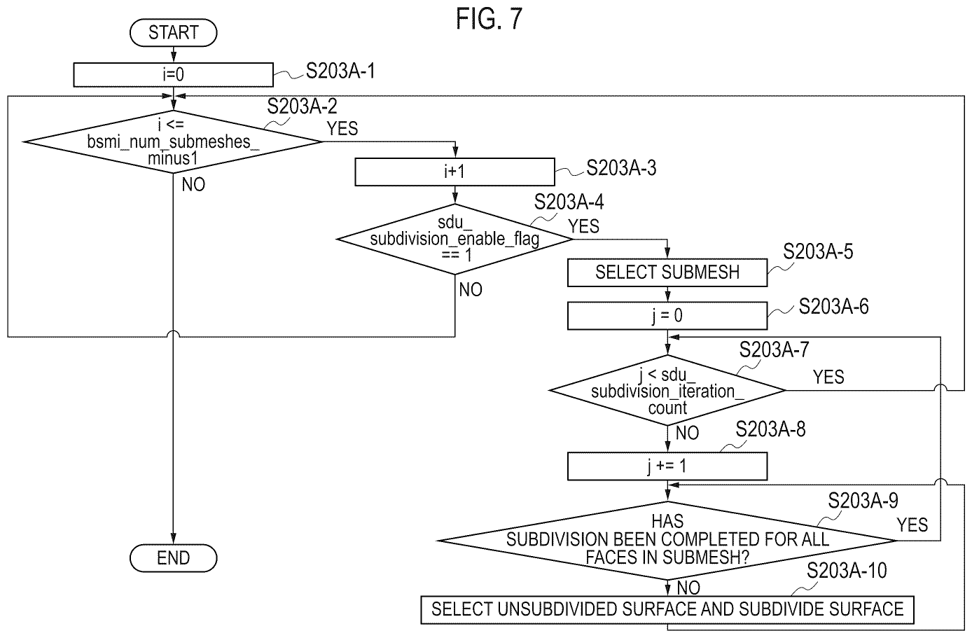

FIG. 7 is a flowchart illustrating an example of processing of the base mesh subdivision unit 203A. Hereinafter, an example of processing of the base mesh subdivision unit 203A will be described with reference to FIG. 7.

As illustrated in FIG. 7, in step S203A-1, the base mesh subdivision unit 203A sets i=0 for the variable i, and proceeds to step S203A-2.

In step S203A-2, the base mesh subdivision unit 203A determines whether the variable i satisfies the inequality i≤bsmi_num_submeshes_minus1. In the case of Yes, the operation proceeds to step S203A-3, and in the case of No, the operation ends. Here, bsmi_num_submeshes_minus1 is a number obtained by subtracting 1 from the submeshes constituting the mesh.

In step S203A-3, the base mesh subdivision unit 203A adds 1 to the variable i.

In step S203A-4, the base mesh subdivision unit 203A determines whether sdu_subdivision_enable_flag, which is a control signal indicating whether to perform subdivision, satisfies sdu_subdivision_enable_flag=1. In the case of Yes, the operation proceeds to step S203A-5, and in the case of No, the operation proceeds to step S203A-2.

In step S203A-5, the base mesh subdivision unit 203A selects an unprocessed submesh. Here, the unprocessed submesh is a mesh not subjected to the subdivision processing.

In step S203A-6, the base mesh subdivision unit 203A sets the variable j to j=0, and proceeds to step S203A-7.

In step S203A-7, the base mesh subdivision unit 203A determines whether j<sdu_subdivision_iteration_count is satisfied for the variable j and the number of times of subdivisions sdu_subdivision_iteration_count. In the case of Yes, the operation proceeds to step S203A-2, and in the case of No, the operation proceeds to step S203A-8.

In step S203A-8, the base mesh subdivision unit 203A adds 1 to the variable j, and proceeds to step S203A-9.

In step S203A-9, the base mesh subdivision unit 203A determines whether subdivision of faces has been completed for all faces in the submesh. In the case of Yes, the operation proceeds to step S203A-7, and in the case of No, the operation proceeds to step S203A-10.

In step S203A-10, the base mesh subdivision unit 203A selects an unsubdivided surface and subdivides the surface. Thereafter, the operation proceeds to step S203A-9.

At this time, the base mesh subdivision unit 203A may subdivide the surface using the Mid-edge division method, or may subdivide the surface using another known subdivision method.

Here, the base mesh subdivision unit 203A may determine the subdivision method for the submesh based on the value of sdu_subdivision_method.

FIG. 5B is an example of subdivision by the Mid-edge division method. In the Mid-edge division method, a subdivision mesh is generated by dividing midpoints of sides constituting a mesh.

### Subdivision Vertex Normal Calculation Unit 203B

The subdivision vertex normal calculation unit 203B is configured to output a normal (subdivision vertex normal) defined for each subdivision vertex for the subdivision vertex constituting the input subdivision mesh.

A plurality of subdivision meshes may be input, and in such a case, the subdivision vertex normal calculation unit 203B may be configured to calculate and output each subdivision vertex normal independently for the plurality of subdivision meshes.

For each submesh, when a value of sdu_subdivision_enable_flag which is a control signal indicating whether to perform subdivision is “0”, the subdivision vertex normal calculation unit 203B may be configured not to calculate a subdivision vertex normal for the corresponding submesh.

### Displacement Amount Decoding Unit 205

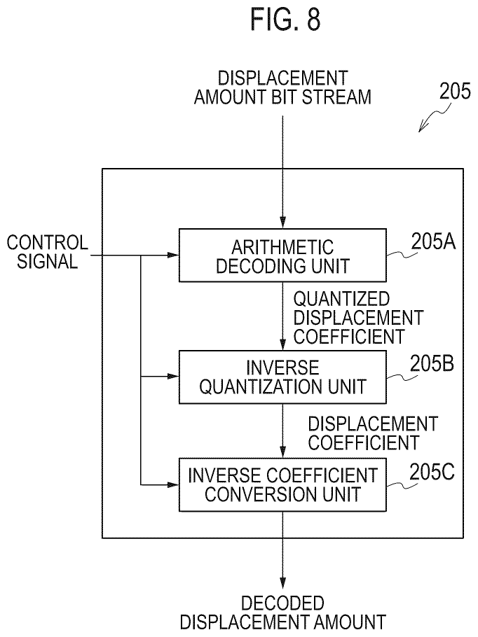

As illustrated in FIG. 8, the displacement amount decoding unit 205 includes an arithmetic decoding unit 205A, an inverse quantization unit 205B, and an inverse coefficient transformation unit 205C.

Here, the displacement amount may be defined to be calculated independently for each submesh.

### Arithmetic Decoding Unit 205A

The arithmetic decoding unit 205A is configured to decode the input displacement amount bit stream using an existing arithmetic encoding method and output the quantized displacement amount coefficient.

When there are a plurality of submeshes, the arithmetic decoding unit 205A may be configured to decode the displacement amount independently for each submesh.

Further, the displacement amount bit stream may be configured to be decoded by using an existing video codec.

### Inverse Quantization Unit 205b

The inverse quantization unit 205B is configured to decode the input quantized displacement amount coefficient and output the displacement amount coefficient.

When the displacement amount encoding method is one-dimensional displacement encoding, the inverse quantization unit 205B may skip the inverse quantization processing for two displacement amount components orthogonal to the normal direction and perform the inverse quantization processing only for the displacement amount normal direction component.

When the quantization value of the displacement amount is set for each LoD for the submesh, the inverse quantization unit 205B may inversely quantize the displacement amount based on the quantization value of the displacement amount of each LoD set in vdmc_transform_lod_quantization which is the displacement amount quantization value defined for each submesh.

Furthermore, the inverse quantization unit 205B may inversely quantize the displacement amount of LoD₀ on the basis of the quantization value set in vdmc_transform_lifting_quantization_parameters.

Furthermore, the inverse quantization unit 205B may calculate a quantization value by multiplying the displacement amount defined for each submesh of LoDᵢ by vdmc_transform_log2_lifting_lod_inverse_scale and vdmc_transform_lifting_quantization_parameters, and inversely quantize the displacement amount of LoDᵢ by the calculated quantization value.

When the quantization value of the displacement amount is set for each LoD for the patch, the displacement amount of each LoD may be inversely quantized based on the quantization value of the displacement amount of each LoD set in vdmc_transform_lod_quantization defined for each patch.

Furthermore, the inverse quantization unit 205B may inversely quantize the displacement amount of LoD₀ on the basis of the quantization value set in vdmc_transform_lifting_quantization_parameters.

Further, a quantization value may be calculated by multiplying vdmc_transform_log2_lifting_lod_inverse_scale and vdmc_transform_lifting_quantization_parameters defined for each patch, and the displacement amount of LoDᵢ may be inversely quantized by the calculated quantization value.

At this time, the inverse quantization unit 205B may perform the inverse quantization by using uniform quantization in Reference Literature (Jinhua Yu, “Advantages of uniform scalar dead-zone quantization in image coding system” in 2004 International Conference on Communications, Circuits and Systems (IEEE Cat. No. 04EX 914). IEEE, 2004, vol. 2, pp. 805-808), or may perform the inverse quantization by using another known inverse quantization method.

### Inverse Coefficient Transformation Unit 205C

The inverse coefficient transformation unit 205C is configured to perform inverse coefficient transform on the displacement amount coefficient output by the inverse quantization unit 205B to output a decoded displacement amount.

At this time, the coefficient transformation method may be determined on the basis of sdu_transform_method which is a control signal representing a displacement amount encoding method for each submesh.

When performing the inverse coefficient transformation, the inverse coefficient transformation unit 205C may skip the inverse coefficient transformation process for the two displacement amount components orthogonal to the normal direction, and perform the inverse coefficient transformation only for the displacement amount normal direction component.

### Mesh Decoding Unit 204

The mesh decoding unit 204 is configured to output the decoded mesh based on the input control information, the subdivision mesh, and the displacement amount.

The mesh decoding unit 204 adds the displacement amount to the input vertex of the subdivision mesh to decode the decoded mesh.

At this time, the mesh decoding unit 204 may output a plurality of decoded meshes for each submesh based on the displacement amount corresponding to the submesh and the subdivision mesh.

Furthermore, the mesh decoding unit 204 may be configured to set a coordinate system of the displacement amount on the basis of a control signal representing a coordinate system of the displacement amount defined for each submesh, and calculate and output the decoded mesh by adding the displacement amount to the subdivision vertex on the set coordinate system.

### Texture Decoding Unit 206

The texture decoding unit 206 is configured to decode an input texture bit stream and output a decoded texture.

The texture decoding unit 206 may be configured to independently decode a texture bit stream corresponding to a submesh using a known video codec to generate a plurality of decoded textures.

The texture decoding unit 206 may be configured to independently decode a part of the decoded texture based on the input control information.

According to the present embodiment, efficient compression can be performed by performing parameter control for each submesh.

Furthermore, according to the present embodiment, the displacement amount can be efficiently compressed by performing quantization for each LoD in units of submeshes or patches.

The mesh encoding device 100 and the mesh decoding device 200 described above may be implemented as programs that cause a computer to execute each function (each step).

Note that, according to the present embodiment, for example, comprehensive improvement in service quality can be realized in moving image communication, and thus, it is possible to contribute to goal 9 “Establish a resilient infrastructure, promote sustainable industrialization, and expand innovation” of the sustainable development goals (SDGs) led by the United Nations.

What is claimed is:

1. A mesh decoding device comprising:
an atlas data decoding unit configured to decode an atlas bit stream to generate and output control information.

2. The mesh decoding device according to claim 1, wherein
the atlas data decoding unit changes the number of dimensions of a control signal representing a displacement amount quantization scale value between subdivision levels to be decoded, based on a control signal representing whether to perform one-dimensional displacement encoding defined for each submesh.

3. The mesh decoding device according to claim 1, wherein
the atlas data decoding unit changes the number of dimensions of a control signal representing a quantization value for each subdivision level to be decoded, based on a control signal representing whether to perform one-dimensional displacement encoding defined for each submesh.

4. The mesh decoding device according to claim 1, wherein
the atlas data decoding unit changes the number of dimensions of a control signal representing a quantization scale value of a displacement amount between subdivision levels to be decoded, based on a control signal representing whether to perform one-dimensional displacement encoding defined for each patch.

5. The mesh decoding device according to claim 1, wherein
the atlas data decoding unit changes the number of dimensions of a control signal representing a quantization value for each subdivision level to be decoded, based on a control signal representing whether to perform one-dimensional displacement encoding defined for each patch.

6. A mesh decoding method, comprising:
decoding an atlas bit stream to generate and output first control information.

7. A non-transitory computer-readable medium having stored thereon a program that is executable by a computer to cause the computer to function as a mesh decoding device, wherein
the mesh decoding device includes an atlas data decoding unit configured to decode an atlas bit stream to generate and output first control information.
